(19) United States
(12) Patent Application Publication
(10) Pub. No.: US 2026/0094119 A1
(43) Pub. Date: Apr. 2, 2026

(54) METHOD AND SYSTEM FOR AUTOMATED GENERATION OF POLICE REPORTS

(71) Applicant: FACTION FOUR SYSTEMS INC., Sherwood Park (CA)

(72) Inventor: Shawn REHILL, Sherwood Park (CA)

(21) Appl. No.: 19/339,870

(22) Filed: Sep. 25, 2025

Related U.S. Application Data
(60) Provisional application No. 63/701,812, filed on Oct. 1, 2024.

(51) Int. Cl. G06Q 10/10; G06F 40/166; G06Q 50/26; G06V 20/40; G10L 15/26

(52) U.S. Cl. CPC G06Q 10/10; G06F 40/166; G06Q 50/26; G06V 20/47; G10L 15/26

(57) ABSTRACT

Examples herein relate to a method and system for automated generation of police reports. In at least one example, the method involves retrieving an event dataset associated with a target event, the event dataset comprising textual event data and media event data, wherein the event dataset is retrieved from a distributed network system comprising a plurality of databases; processing the media event data to generate corresponding media-based textual data; generating a textual event dataset comprising (i) the textual event data, and (ii) the media-based textual data; inputting the textual event dataset into a trained natural language model (NLM); and outputting a police report from the NLM.

### CROSS-REFERENCE TO RELATED APPLICATION(S)

This application claims the benefit of, and priority to, U.S. Provisional Patent Application No. 63/701,812, filed on Oct. 1, 2024, the entirety of which is incorporated herein by reference.

### FIELD

Disclosed examples generally relate to generating police incident reports, and in particular, to a method and system for automated generation of police reports.

### BACKGROUND

In the course of drafting a police report, an officer must typically track down data, relevant to an incident, stored in various databases and servers. This includes data stored in digital evidence management (DEM) databases, officer note databases, record management systems and dispatch and event systems. Once all data is compiled, the data is then aggregated into a coherent and consistent report that complies with standard protocols and practices for police reporting.

### SUMMARY

In accordance with a broad example, there is provided a method for automated generation of police reports, comprising: retrieving an event dataset associated with a target law enforcement event, the event dataset comprising textual event data and media event data, wherein, the event dataset is retrieved from a distributed network system comprising a plurality of law enforcement databases; processing the media event data to generate corresponding media-based textual data; generating a textual event dataset comprising (i) the textual event data, and (ii) the media-based textual data; processing the textual event dataset using a trained natural language model (NLM), wherein the NLM is prompted to generate a police report according to a predefined set of rules; and outputting the police report from the NLM.

In another broad aspect, there is provided system for automated generation of police reports, comprising: a distributed network system comprising a plurality of law enforcement databases; and a non-transitory memory storing computer executable instructions, which when executed by at least one processor, cause the processor to execute the above described method.

In different embodiments, the present invention may comprise a method or system comprising any combination of elements or features described herein, or which specifically omits any particular feature or element described herein.

### BRIEF DESCRIPTION OF THE DRAWINGS

In the drawings, like elements may be assigned like reference numerals. The drawings are not necessarily to scale, with the emphasis instead placed upon the principles of the present disclosure. Additionally, each of the embodiments depicted are but one of a number of possible arrangements utilizing the fundamental concepts of the present disclosure.

FIG. 1A is an example system for automated generation of police reports.

FIG. 1B is an illustration of an example police report.

FIG. 2A is a process flow for an example method for automated generation of police reports.

FIG. 2B is a process flow for an example method for processing media event data to generate text-based media data.

FIG. 2C is a process flow for an example method for applying a trained natural language model (NLM) for automated generation of a police report.

FIGS. 3A-3F are screenshots of various graphical user interfaces (GUIs) used for automated generation of police reports.

FIG. 4 is a simplified hardware block diagram for an example processing server.

### DETAILED DESCRIPTION OF THE EMBODIMENTS

As used herein, a “police report” refers to a formal document generated by law enforcement officers that records details of an incident, investigation, or crime. It includes facts such as the time, date, location, individuals involved, witness statements, and any actions taken by the authorities. As contrasted to other types of written documents, a police report has a specific structure, format and writing style to allow the report to serve as an official legal account and to be admissible as evidence in legal proceedings.

### I. General Overview

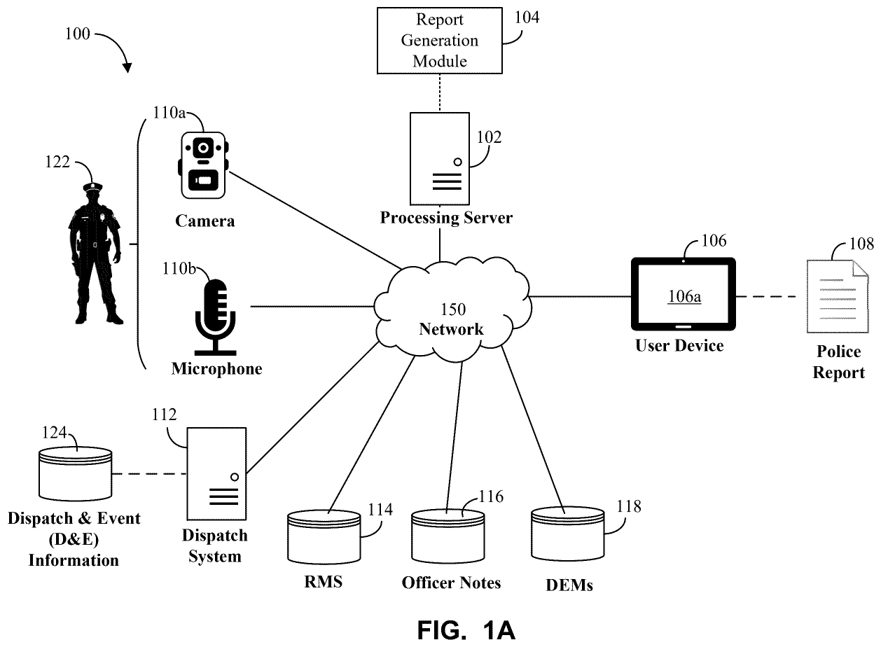

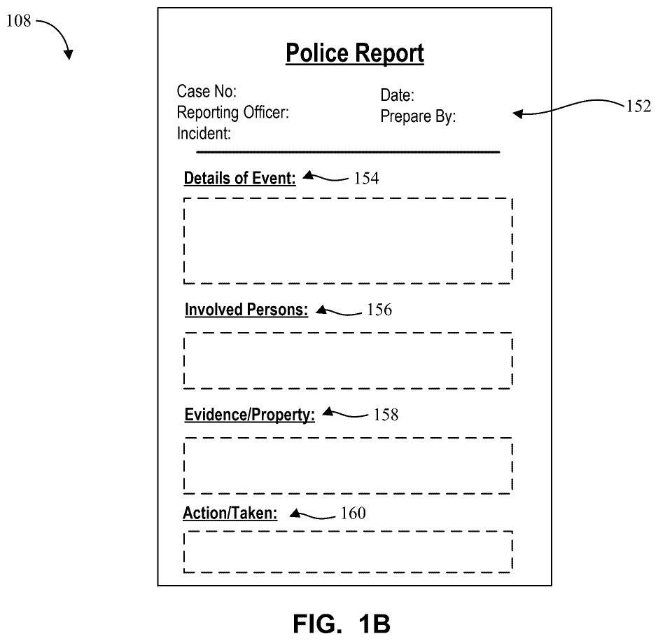

FIG. 1B exemplifies a standard police incident report 108, which may be generated by the disclosed examples.

As police reports are often used as evidence in legal proceedings, these reports must satisfy certain guidelines and protocols relating to their structure and form.

By way of example, as shown, a police report 108 is often structured into standardized sections including: (i) a preamble 152 (e.g., case number, officer, incident type, etc.), (ii) a narrative of event details 154 (e.g., detailed account of incident), (iii) involved persons 156 (e.g., information about victims, suspects and witnesses), (iv) list of evidence/property 158 (e.g., items related to the crime or incident), and (v) actions/taken 160 (e.g., arrest, warnings or other actions taken by the officer). Depending on the jurisdiction, the report 108 may include further additional information.

In addition to its structure, the police report 108 must also be written according to a certain form. For example, the report should be written in a clear and objective tone. Further, the events described in the narrative section 154 must be written in chronological order. Guidelines also dictate certain rules regarding the form of identifying information (e.g., locations and names), use of consistent terminology and use of exact quotations from witnesses or suspects.

Current processes for generating police reports are time-intensive, inaccurate and inefficient. This is because, for each police report, the user (e.g., police officer) is required to use a computer to manually: (i) locate relevant data to the incident, whereby such data is often stored in different computer file locations, as well as different network-wide systems and servers; and (ii) convert different non-standardized data file formats (e.g., image and audio) into a common standardized format (e.g., textual format), suitable for entry into a report. Once all data is aggregated and converted, the user must then compile the report. Alternatively, software dedicated to these functions may require a time-consuming process and substantial computational resources to perform steps (i) and (ii).

In view of the foregoing, disclosed examples relate to a method and system for automated generation of police reports.

As explained, examples herein address a technical problem in enabling a computer system to automatically: (i) locate all relevant data to an incident, even where such data is stored in separate servers, systems and databases; (ii) process and standardize the format of this unstandardized data into a common textual form that can be analyzed and processed by a large natural language model (NLM); and (iii) apply the NLM to convert the textual data into a police report that is comprehensive, coherent, and accurate. In at least one example, the NLM is commanded to process the textual data according to a set of predefined rules that ensure the report adheres to required legal standards and protocols.

### II. Example System

FIG. 1A shows an example system 100 for automated generation of police reports, in accordance with disclosed examples.

Broadly, system 100 includes a processing server 102. Processing server 102 hosts and executes a report generation module 104, which automatically generates a police report 108.

As provided herein, the report generation module 104 can comprise a natural language model (NLM). In use, the module 104 receives a textual data input related to a case or incident, and automatically generates the textual police report 108. Module 104 may also take an input comprising rules for generating the report 108, such that the report 108 conforms with legal protocols and standards for police report documents.

In some examples, system 100 includes a user device 106. User device 106 can include a display interface 106a for displaying the police report 108. The user device 106 may couple to network 150 such that it receives the police report 108 from server 102 (via network 150).

In some cases, the report generation module 104 is hosted on the user device 106, in addition or in the alternative to the processing server 102.

In addition to user device 106, system 100 includes various servers, systems and devices that generate or store data necessary to generate the police report 108. Collectively, these may define a distributed network system of databases and servers.

As exemplified, the databases and servers include: (i) media devices 110, (ii) dispatch system 112, (iii) records management system (RMS) 114, (iv) officer notes database 116, and (v) digital evidence management (DEM) database 118.

Media devices 110 include various devices for generating media data. As used herein, “media data” includes image and/or audio data. The image data includes image frame data, such as video data.

In this example, media devices 110 include one or more (i) cameras 110a for generating image or video data; and/or (ii) microphones 110b for generating audio data. It is possible that the camera and microphone are integrated into a single hardware device. Media devices 110 more generally include any device that generates media data (e.g., any image or audio sensor).

In use, media devices 110 operate to generate media data associated with an incident. For example, media devices 110 include cameras and microphones worn by the police officer 122. These devices record interactions or conversations between the officer and people or objects present at the scene of an incident.

Media devices 110 are not limited, however, to only devices worn by the officer, and include other devices located at or around the incident. For instance, these include police vehicle-mounted dash cameras, closed-circuit television (CCTV) cameras, or otherwise other audio/video recording devices the officer 122 is carrying or holding.

It is understood that, in the system 100, there may be in fact more than one camera and/or microphone. For example, if multiple officers are present at the scene, then each officer may have an associated camera or microphone.

In at least one example, media data generated by media devices 110 is transmitted and stored in other databases located in system 100 (e.g., systems and databases 112-118). When the media data is stored therein, it may be stored in association with the related incident, such as by tagging the media data with a case or incident specific identifier.

Dispatch system 112 stores a dispatch and event database 124. The dispatch system 112 can be a computer-aided dispatch (CAD) system.

As known in the art, a dispatch system tracks and manages deployment of law enforcement. Accordingly, the dispatch system stores dispatch data including call log details (e.g., 911 call logs) and incident location. The incident location data includes various location data generated by location systems, e.g., carried by the officer or the officer's car.

Records management system (RMS) 114 stores information about entities associated with a case incident. For example, this includes historic individual data including historical data about previous crimes performed by an individual and/or associated citations/tickets, arrests, warrants, historical officer notes and historical field interviews. It may also include information about businesses, as well as certain objects (e.g., vehicles) relevant to the incident. More generally, the RMS 114 represents “structured” data (e.g. data in a database that describes a record such as a person, vehicle, address, property, event, police report, etc.).

Officer notes database 116 stores notes that a police offer obtains when responding to a call event. For example, these include typed notes of the incident, as well as the various images and audio captured by the officer. In at least one example, the officer notes are entered through a user-friendly interface or via speech-to-text transcription.

Digital evidence management (DEM) database 118 can store various digital exhibits associated with the event (e.g., photos, audio, video, etc.). For example, this can include various types of media captured by media devices 110a, 110b. It may also include various media captured through officer applications, e.g., Smart Squad™ application. Generally, the media stored in the DEM 118 includes any media captured by the officer or any other media related to the event.

### III. Example Method(S)

The following is a description of various example methods for automated generation of police reports. In some examples, the disclosed methods are performed in real time or near real time.

### (i.) Method for Automated Generation of Police Reports.

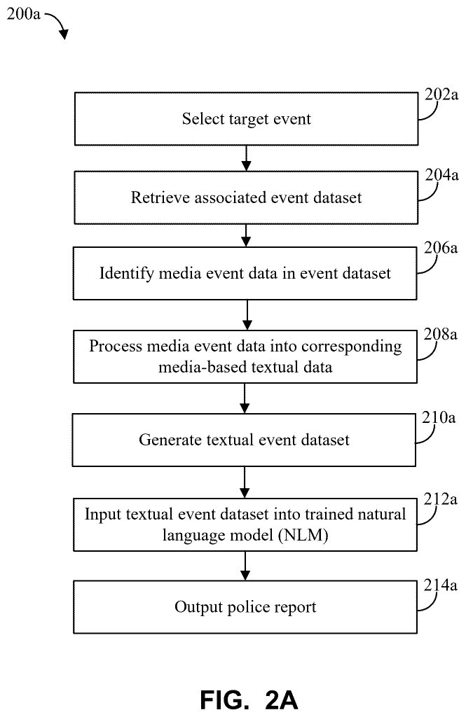

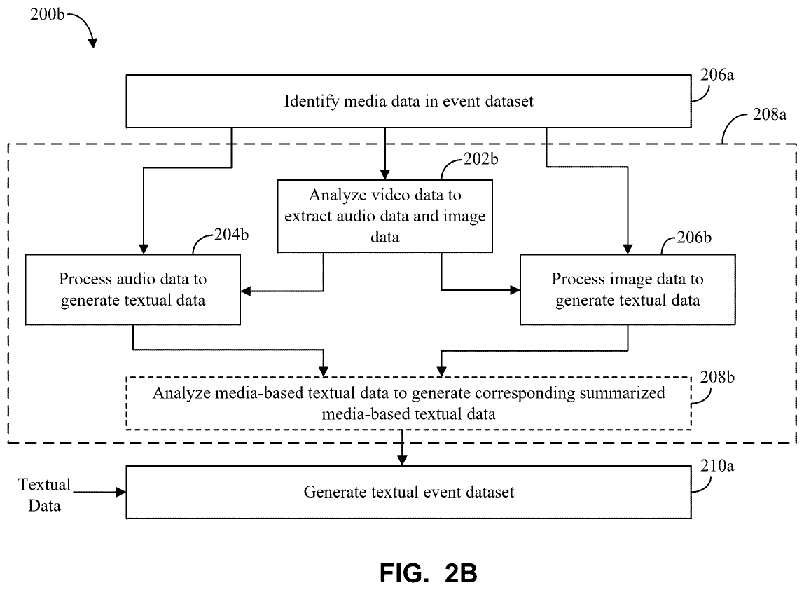

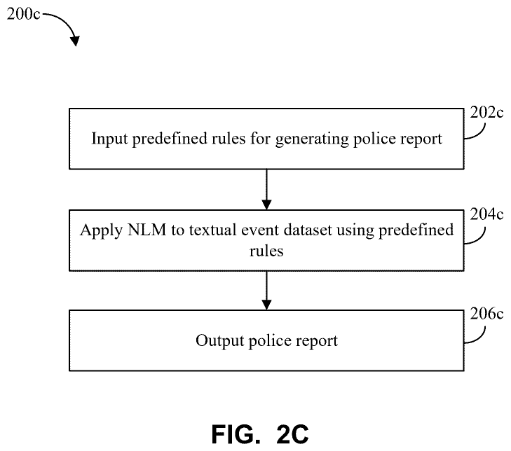

FIG. 2A shows a process flow for a method 200a for automated generation of police reports. In some examples, method 200a is performed by a processor of the processing server 102 (FIG. 1A). For instance, method 200a is performed while the processor 102 is executing the report generation module 104.

At 202a, a target event is selected for generating an associated police report. The target event relates to an incident or case that a police officer has responded to previously (e.g., a law enforcement incident or event).

In some examples, the target event is selected, at 202a, via the user device 104 (FIG. 1A). For instance, a user (e.g., a police officer) can access a graphical user interface (GUI) that enables selecting the target event.

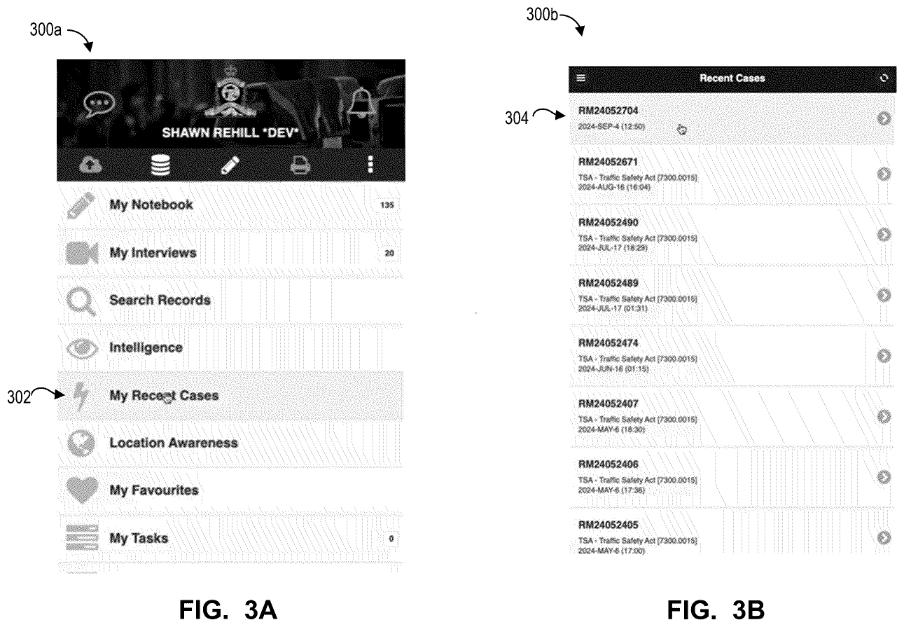

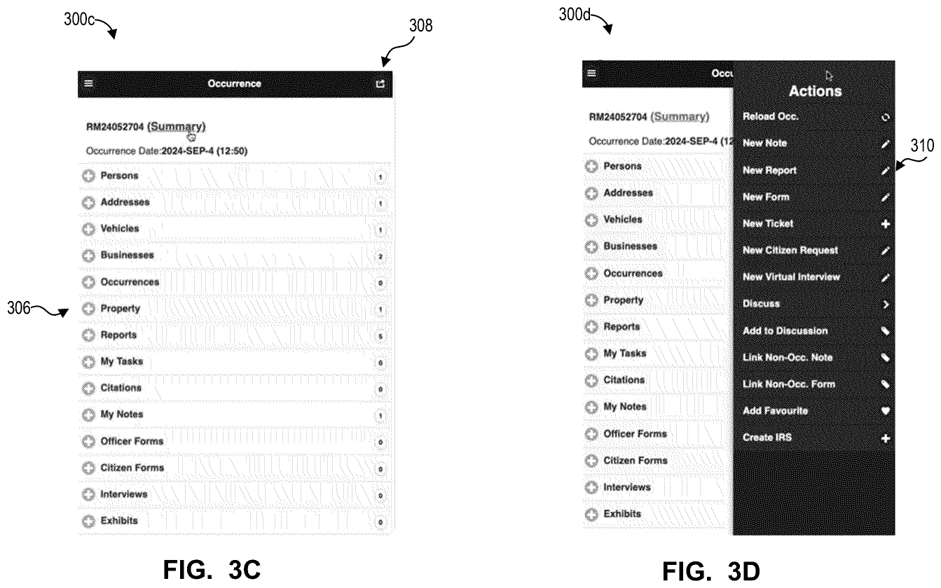

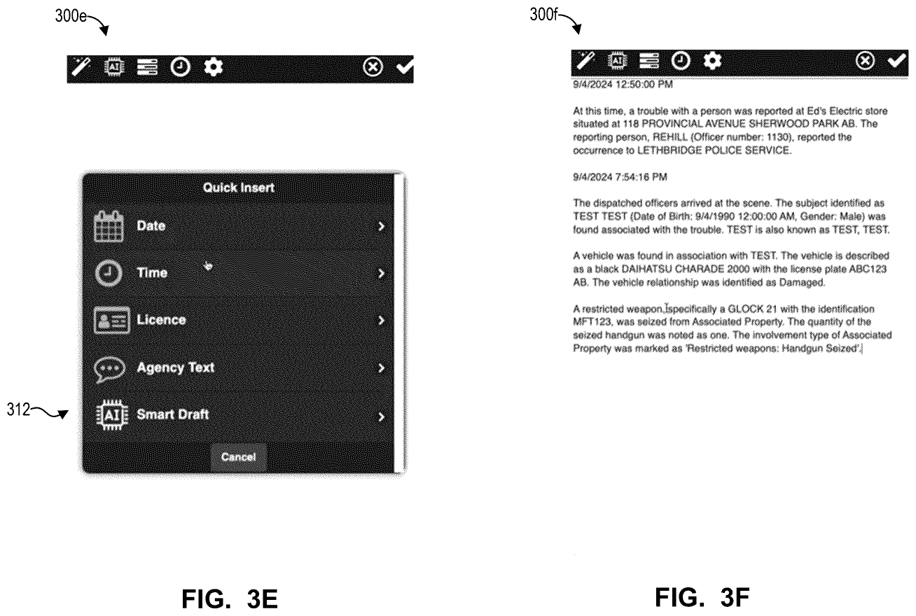

By way of example, FIG. 3A shows a screenshot of GUI 300a that allows the officer to initiate generating an automatic report by selecting “My Recent Cases”. In FIG. 3B, the GUI 300b displays a list of the most recent cases involving the officer. This list includes a summary of the case reference number (e.g., RM24052704), as well as a short summary of the incident (e.g., TSA-Traffic Safety Act) along with the incident date. This allows the officer to select an incident 304 to generate the corresponding report.

In FIG. 3C, the system may further display to the officer, in GUI 300c, an aggregate summary of all relevant data 306 for that event. The officer may select the input 308, which is shown in GUI 300d (FIG. 3D). This then allows the officer to select “new report” 310, which further leads the officer to GUI 300e (FIG. 3E) to select generating a “Smart Draft” 312. Accordingly, the aggregation of GUIs 300a-300e correspond to selection of the target event, at 202a (FIG. 2A).

In other examples, it is possible that the officer inserts a unique identifier (ID) associated with the target event, and requests generating a report for that event. The system may also simply automatically generate a police report for specific events, such as automatically generating a report for the most recent event. As such, the systems herein are not limited to the form or manner in which the target event is selected.

Continuing reference to FIG. 2A, at 204a, the system retrieves the event dataset associated with the target event. This includes retrieving all data, stored in any of the systems or databases (FIG. 1A), that are associated or related with the target event.

For example, in FIG. 1A, this involves retrieving all media data, generated by the media devices 110 or otherwise, associated with the target event. This includes various audio, video and image frame data that is stored on various systems and databases 114-124 (as described above). The media data may be generated by media devices located at or near the incident location, and which capture media related to that incident. It also includes retrieving the associated dispatch and event information, from the D&E database 124 as well as officer note information from database 212.

The RMS database 114 is also accessed to identify information relating to entities associated with the event (e.g., people, companies or vehicles). In at least one example, the system identifies the relevant entities based on the dispatch information. Once the relevant entities are identified, the system accesses the RMS 114 to retrieve information about these entities.

At 206a, media event data, in the event dataset, is identified. For instance, this includes audio data, image data and video data.

At 208a, the media event data is processed into corresponding media-based textual data. As explained below, the audio data is converted into a textual summary, e.g., summaries of audio conversations. In at least one example, video and image data are further processed to extract features, and represent these features as text. For instance, an image is analyzed to identify various aspects of an incident or crime scene, which are then represented textually for the purpose of the police report.

At 210a, a textual event dataset is generated. The textual event dataset includes an aggregation of (i) the media-based textual data generated at 208a, as well as (ii) any other textual data initially retrieved at 204a (e.g., any data in textual format, as described above in relation to the various databases). In some examples, each piece of textual data is annotated with a data type identifier (e.g., records, evidence, etc.).

At 212a, the textual event dataset is input into a trained natural language model (NLM). The method of inputting and applying the NLM is further discussed in method 200c (FIG. 2C).

At 214a, the trained NLM processes the textual event dataset to generate an output police report. The output police report is in the form of a textual report that compiles and aggregates the textual event dataset according to a format, style and structure common to police reports (see e.g., FIG. 1B and associated description).

There is no limit to the type of output generated at 214a. In some cases, the police report is transmitted from the processing server 102 to one or more user devices 106 for display. For instance, in FIG. 1A, the police report may be output on a display interface 106a of the user device 106. FIG. 3F shows a GUI 300f of an example output police report generated by the system. In other examples, the police report is stored on a memory for later access, such as on a memory of the server 102 and/or user device 106. In other cases, the final report is exported in various other formats for record-keeping and sharing as required.

In at least one example, after the police report is output on the user device 106-a user (e.g., police officer) is permitted to make edits and changes to the report, as desired.

(ii.) Method for Processing Media Event Data into Media-Based Textual Data.

FIG. 2B is a process flow for an example method 200b for processing media event data into media-based textual data. Method 200b is performed during acts 206a-210a of method 200a (FIG. 2A).

At 206a, media data is identified in the event dataset. This corresponds to act 206a (FIG. 2A).

As explained previously, media data can include video data, image data as well as audio data. For example, this can include video or image frames generated by the camera 110a, or audio data generated by the microphone 110b. Typically, the media data is data that is associated or relevant to the target event, e.g., case or incident.

At 202b-206b, each type of media type data is processed to generate corresponding media-based textual data.

For example, at 202b, in respect of any video data, the video data is processed to extract and separate the audio data and image frame data. Each of the audio and image frame data may be stored and processed as separate computer files.

By way of example, various techniques are known in the art for separating audio data from video data. Such techniques may involve the use of media conversion utilities that parse a multimedia container file and output discrete audio and video streams, command-line tools that demultiplex encoded data into separate tracks, or audio processing programs capable of opening video files and exporting the audio portion as an independent file.

At 204b, the audio data is processed to convert the audio into corresponding textual data. This can be audio data generated from an audio sensor (e.g., microphone), or audio data extracted from video data (202b) using tools known in the art.

In some examples, at 204b, the system may employ automatic speech recognition (ASR) engines, such as those provided by Azure™ Speech-to-Text or Google™ Speech Recognition, to transcribe spoken audio words into text.

In some cases, these ASR tools utilize advanced machine learning algorithms to accurately identify and convert speech, even in noisy or variable environments typical of law enforcement scenarios. In some implementations, the system may further apply language models or context-aware post-processing techniques to improve the accuracy and coherence of the transcribed text, ensuring that the resulting data is suitable for integration into structured police reports.

At 206b, the image data is also processed to convert the images into corresponding textual data. The textual data can describe events or objects within the images, or image frames. The image data can be generated from a camera, or otherwise extracted from the video data (202b).

The image-to-text conversion may be performed using various image-to-text processing software that are well known in the art, including artificial intelligence and machine learning products such as Azure™ Computer Vision or Google™ Cloud Vision. These tools are capable of performing optical character recognition (OCR) to extract any textual information present within the images (e.g., license plate information), as well as object detection and scene analysis to identify and classify predefined objects, persons, or activities relevant to the incident. A textual summary of the image frame is then generated.

To this end, various object detection models and descriptors are also known in the art for analyzing image data to identify and classify features of interest and generate textual descriptors. Classical feature-based techniques include descriptors such as Scale-Invariant Feature Transform (SIFT), Speeded Up Robust Features (SURF), Histogram of Oriented Gradients (HOG), and Oriented FAST and Rotated BRIEF (ORB), which are applied to extract distinctive local features from images. More recent advances employ deep learning architectures such as the R-CNN family (R-CNN, Fast R-CNN, Faster R-CNN, and Mask R-CNN), Single Shot MultiBox Detector (SSD), You Only Look Once (YOLO) models, RetinaNet, EfficientDet, and transformer-based models such as DETR (DEtection TRansformer).

In some examples, the system is configured to extract predefined concepts and objects from the images, such as vehicle license plates, street signs, weapons, articles of clothing, or other context-specific features. These predefined concepts may be selected to capture information particularly relevant to a police report, incident record, or investigative file

For instance, automated license plate recognition may be applied to identify and log vehicle information, while sign detection may provide geographic context or evidence of traffic violations. The system can further perform weapon detection to flag potential threats.

In many cases, image-to-text conversion programs are pre-trained on large datasets to recognize and extract a wide variety of information, including textual content, objects, and contextual features. Such programs can operate in a general mode, where they automatically identify and output a broad set of information types based on their prior training. In other instances, the programs can be directed to extract only specific categories of information that are of interest to the user or system. For example, the program may be instructed, through prompts, configuration settings, or predefined rules, to focus on extracting license plate numbers, particular signage, or objects associated with law enforcement incidents. Thus, the same underlying model can be applied both as a general extractor of diverse information and as a targeted tool for retrieving only desired information relevant to the task at hand.

In addition to identifying predefined objects, the system can generate descriptive captions for the images that summarize scene content in natural language. The analysis may also extend to auxiliary insights, such as detecting the presence and approximate number of individuals, inferring the time of day from lighting conditions and shadows, estimating environmental context (e.g., indoor versus outdoor), or recognizing law enforcement equipment and uniforms.

In this manner, the system not only extracts targeted information but also produces broader semantic annotations that enrich the evidentiary value of the image data.

In at least one example, at act 206a, and 202b-206b, the system may determine how to process the media data based on a source identifier for the media data.

For example, for video data, the system can initially determine the source of the video data, such as whether the video is generated by a CCTV camera or a body worn camera. If a video is generated by CCTV, then at 202b, the video data is not analyzed to extract audio data at 202b. This is because the audio, generated by a CCTV, may not be useful and is otherwise irrelevant to generating a police report. As such, the system filters out the associated audio data. This, in turn, may reduce computational processing requirements by only analyzing non-audio data.

In some examples, the source identifier for media data is determined based on data stored in association with the media file, e.g., metadata that may indicate the source or source indicia.

In at least one example, to determine how to process given media data, the system can: (i) first, determine the media type associated with each piece of media data (e.g., video, audio, image); (ii) second, determine a source classification for that media data—the classification can indicate the source of the media; and (iii) third, based on the classification and media type, determine how to process that media data to generate the media-based textual data. With respect to (iii), this involves determining whether to process the media data to generate media-based textual data, and if so, what type of processing is involved (e.g., audio and/or video).

To this effect, the system can store one or more predefined processing rules which determine how each combination of media type and source classification is processed using method 200b, at step (iii). In various cases, the predefined processing rules are based on the relevance of that data type to generating a police report (e.g., CCTV vs body-worn video). Again, these processing rules may be used for more efficient and streamlined processing of media data, which may assist in real time or near real time applications.

At 208b, in some cases, the textual data generated from each source is summarized and abbreviated. For example, this may involve applying an automated system, as known in the art, which analyzes text and generates an abbreviated summary.

In some instances, this may involve applying a natural language model for text summarization, such as transformer-based models (e.g., BERT, GPT, or similar architectures) that are trained to condense lengthy or detailed transcriptions into concise, contextually relevant summaries. These models can identify key facts, filter out extraneous information, and present the essential details in a clear and structured manner. Additionally, the system may utilize rule-based algorithms or extractive summarization techniques to ensure that critical information (e.g., names, dates, locations, and actions taken) is retained in the summary. This automated summarization not only reduces the volume of data that must be processed in subsequent steps but also enhances the clarity and usability of the information incorporated into the final police report.

At 210a, the media-based textual data is generated based on a combination of 208b, as well as the textual data in the original event dataset.

(ii.) Method for Generating Police Report using NLM.

FIG. 2C shows a process flow for an example method 200c for using the trained natural language model (NLM) to generate the output police report. Method 200c is performed during 212a and 214a in method 200a (FIG. 2A).

In this process, the NLM (e.g., a large language model based on transformer architectures (for example, GPT, BERT, or similar models)) receives the aggregated textual event dataset as input, along with a set of predefined rules that govern the structure, formatting, and content of the generated report. The NLM processes the input data to produce a coherent, contextually accurate, and legally compliant police report.

For instance, the NLM may be instructed to organize the report into standardized sections, such as a preamble, narrative of event details, involved persons, evidence/property lists, and actions taken, in accordance with law enforcement protocols. The NLM can also apply specific formatting rules, such as using full names on first mention and last names thereafter, converting GPS coordinates to street addresses, or standardizing units of measurement. Additionally, the NLM may be configured to write the narrative in the third person and to exclude subjective or opinion-based statements, ensuring the report maintains the objectivity required for legal documentation. The output police report is then ready for review, further editing, or direct integration into law enforcement record-keeping systems.

At 202c, predefined rules for generating the police report are input into the system hosting the NLM. These predefined rules define a rule set for generating a police report in accordance with applicable rules for generating these types of reports.

Generally, the predefined rules relate to: (i) structural rules—the structure of the textual data in the police report; and (ii) formatting rules—adjustments to the textual data to conform with the requirements of a police report. In some cases, the rules are different for the type of event the police are responding to (e.g., theft v. assault). Example predefined rules include the following:
Structural Rules—Various structural rules may be provided for structuring data in the police report. These include:
   Organizational Structure Rules—The NLM is configured to organize the textual data into different police report sections. For instance, as shown in FIG. 1B, this includes organizing and aggregating the textual data into an event details sections, as well as sections on involved persons, addresses, property, and further sections on captured officer notes, by way of non-limiting examples.
   In at least one example, the organizational structure rules involve configuring the NLM to (i) identify data categorizations for different textual data (e.g., event data, address data and vehicle data); and subsequently (ii) coalesce together data of the same categorization.
   In some cases, identifying the data categorization is performed in various manners including by extracting metadata or other identifiers associated with the data. In other cases, determining the data source may implicitly indicate the data categorization. For example, data from the officer notes database 116 can indicate that this data corresponds to officer notes.
   Chronological Event Structure Rules—The NLM is configured to detect the time and date of each new entry in the event dataset. The events are then ordered chronologically to generate a chronological narrative in the event data section, with each new entry identified based on the time and date entry.
   In at least one example, in applying the chronological structure rules, the NLM is configured to extract time data (e.g., date and hour) from each textual data.
   For example, with respect to transcribed audio data, this involves analyzing the textual data to extract transcribed time data. In particular, an audio narration may include a dictation by the speaker that the audio was recorded on a specific date. This date is then transcribed into the textual data, and then extracted by the NLM.
   In respect of other forms of textual data (e.g., stored documents and reports), the NLM processes any associated data, such as metadata or file save times, that indicate the event time. More generally, the NLM analyzes textual data to identify any time data embedded or contained therein.
   Once the NLM has associated each textual data with an associated time, the NLM is then configured to: (i) identify textual data having common time data; (ii) aggregate textual data with common time data; and (iii) chronologically organize the aggregated textual data in order of time.
Formatting Rules—Various rules are also provided to conform the police report with standard police report documents. These include:
   Naming Formatting Rules—If an individual's name is detected in the textual data, the NLM is required to use the first name and last name when the individual is mentioned for the first time, and only use the last name for subsequent mentions. If the names of two individuals are detected, whereby two individuals share the same last name, the NLM is required to use first name and last name through all instances of mentioning both subjects to avoid confusion.
   Location Formatting Rules—If a GPS coordinate is mentioned in an event, the NLM should remove the GPS coordinate and state only the location.
   Weather-Related Rules—If weather and/or temperature are mentioned in an entry, the NLM should (a) determine if the weather and temperature are related to the incident; and (b) if so, include mention of the weather and temperature, otherwise remove their mention.
   Unit Conversion Rules—Any units detected in the textual event dataset should be converted into a predefined form. For example, this includes converting wind speed from m/s to km/hr and rounding to near one. In another example, if weather and/or temperature are in Fahrenheit, these may be converted to Celsius, or vice-versa.
   Narrative Rules—Commanding the NLM to write the report in third person to maintain formality and clarity for the entirety of the written report. The NLM is also required, more generally, to use clear words and to avoid opinionative or subjective statements.

At 204c, the NLM is applied to the textual event dataset using the predefined rules. As noted, the NLM can be a large language model (e.g., ChatGPT™) that uses natural language processing (NLP) techniques to understand the context and details of the incident. In this context, the predefined rules may be provided to the NLM as prompts, i.e., structured textual instructions that guide the model's output behavior.

Prompting involves supplying the NLM with explicit directions, constraints, or templates alongside the input data, thereby conditioning the model to generate responses that adhere to specific requirements.

For example, the prompt may include instructions such as: “Organize the following information into a police report with sections for preamble, narrative, involved persons, evidence, and actions taken. Use full names on first mention, convert GPS coordinates to street addresses, and write in the third person.” By embedding these rules within the prompt, the NLM is technically constrained to follow the desired structure, formatting, and content guidelines during report generation. This approach leverages the model's ability to interpret and execute complex instructions, ensuring that the resulting police report is not only contextually accurate but also compliant with legal and procedural standards. In some cases, the prompts are input into a GUI interface displayed on a user device.

Large natural language models suitable for use as the NLM are typically developed through a pre-training process in which the model is exposed to vast amounts of textual data. During pre-training, the model learns statistical associations between words, phrases, and sentences by predicting missing or subsequent tokens within a sequence. The pre-training process is generally unsupervised or self-supervised, relying on objectives such as masked language modeling or next-token prediction. Following this stage, the model may be refined through additional supervised or reinforcement learning steps (e.g., fine-tuning on annotated data or aligning with human feedback) to enhance its performance for downstream tasks. As a result, the pre-trained NLM can encode a broad representation of language structure and semantics, which allows it to interpret and generate contextually relevant responses when applied to textual event datasets in accordance with the predefined rules.

In certain examples, the pre-training and subsequent fine-tuning of the NLM may include exposure to corpora that are representative of law enforcement contexts. Such corpora may include prior police reports, witness statements, officer narratives, transcripts of interviews, associated evidentiary documents, metadata describing locations or times of incidents, and even auxiliary media-derived data such as image captions or audio transcripts that were originally used in the preparation of reports. By training on such material, the NLM can learn the conventions, terminology, and contextual relationships that are commonly present in incident documentation, thereby improving its ability to interpret new textual event datasets and generate outputs that align with investigative or reporting standards.

Various training techniques are commonly employed in connection with such models. In addition to general pre-training, the NLM may undergo fine-tuning on smaller, curated datasets to specialize it for particular reporting tasks. Fine-tuning may be supervised, where the model is trained to reproduce desired outputs from annotated examples, or semi-supervised, where a combination of labeled and unlabeled data is used. Reinforcement learning approaches may also be applied, in which the model is optimized to follow preferred response patterns based on scoring functions or human feedback. Other approaches include parameter-efficient tuning techniques, such as adapters or prompt tuning, which allow the base pre-trained model to be adapted to the law-enforcement domain with fewer computational resources.

At 206c, the police report is output by the NLM. The NLM is able to generate coherent and contextually accurate narratives based on the input data and ensuring consistency, inclusion of all pertinent details and adherence to law enforcement reporting standards and protocols.

### (iii.) Real Time or Near Real Time Application.

The methods described in 200a-200c are adaptable for both retrospective and real-time applications. In some examples, the system may retrieve event data from storage after an incident has occurred, allowing for the automated generation of police reports based on previously collected and archived data.

In other examples, the methods can be implemented in real time or near real time, wherein media data (e.g., audio, video, or images) is received continuously or periodically via a network from field-deployed media devices. As new data is captured and transmitted, the system can process, convert, and integrate this information on an ongoing basis, enabling the generation of up-to-date police reports that reflect the most current details of an incident

In some cases, the operation of media devices, such as body-worn cameras or microphones, may be initiated as part of method 200a, ensuring that relevant media data is captured and made available for immediate processing.

### IV. Example Hardware Configuration for Processing Server

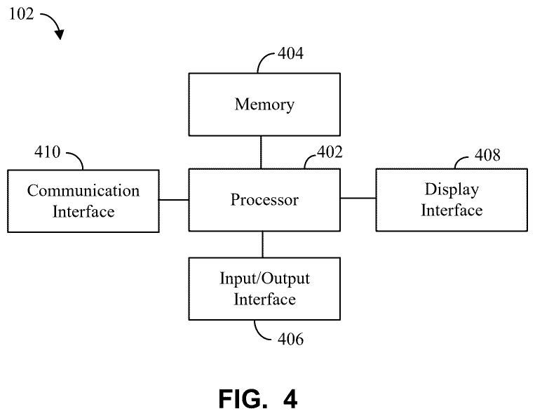

FIG. 4 shows a simplified hardware configuration for an example processing server. As shown, the processing server 102 may include a processor 402 coupled to a memory 404, and one or more of an input/output interface 406, display interface 408 and communication interface 410.

Processor 402 refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors.

Memory 404 refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media.

Memory may be non-volatile or volatile. Instructions stored by a memory may be based on a plurality of programming languages known in the art, with non-limiting examples including the C, C++, Python™, MATLAB™, and Java™ programming languages.

In some examples, memory 404 stores the report generation module 104. Memory 404 may also store the various methods described herein, including methods 200a-200c (FIGS. 2A-2C).

It will be understood by those of skill in the art that references herein to processing server 102 as carrying out a function or acting in a particular way imply that processor 402 is executing instructions (e.g., a software program) stored in memory 404 and possibly transmitting or receiving inputs and outputs via one or more interfaces.

Input/output interface 406 can be any interface for coupling external computing systems to the processing server 102.

Display interface 408 can be any interface for displaying audio and/or visual data, including a display screen. In some examples, display interface 408 can also include a user input interface, such as in a touch screen (e.g., capacitive touch screen).

Communication interface 410 is any interface that enables wireless or wired communication over a communication network, such as network 150 (FIG. 1A). For example, this can be an antenna.

In some examples, the processing server 102 can also include a user input interface for inputting data, e.g. a keyboard and mouse.

### V. Technical Contribution and Practical Application

From a technical perspective, disclosed examples address several limitations of conventional computing systems used for police report generation. Existing computing systems often struggle with inefficient cross-database data retrieval, leading to increased processing times. To this end, disclosed examples introduce an optimized computing architecture for automated data aggregation across distributed databases, enabling faster and more reliable access to relevant event data, even when such data is disparately located across a network.

The system is also capable of converting various non-standardized file formats (e.g., audio, image, and video) through complex image and audio analysis, and standardizing all retrieved data into a common, unified textual format that may be used for police report generation. This standardization reduces the computational overhead typically associated with data conversion and integration, and ensures that all relevant information, regardless of its original format, can be processed uniformly.

Furthermore, examples herein leverage advanced media-to-text processing techniques that minimize memory usage and accelerate the extraction of pertinent information from audio and image sources. This approach allows for scalable handling of large volumes of media data without compromising system performance.

Additionally, the system produces output in a data form that is directly accepted by law enforcement record-keeping systems, facilitating seamless data form integration into existing databases and workflows. For example, many police report databases require information to be provided in standardized structured textual fields, which are then stored in predefined data fields within a relational or non-relational database.

The application of predefined rules to the natural language model (NLM) further enhances efficiency by streamlining the report generation process, ensuring that output documents consistently adhere to jurisdictional standards for structure and formatting. This rule-based processing reduces the need for iterative post-processing and validation, thereby conserving computational resources and improving throughput.

The practical application of the disclosed examples is particularly significant in the context of law enforcement operations. By enabling the automated and efficient generation of police reports from distributed and heterogeneous data sources, the system directly supports the timely and accurate documentation of incidents, investigations, and evidence. This capability allows law enforcement agencies to produce official records that are consistent, comprehensive, and compliant with legal standards, thereby enhancing the evidentiary value and reliability of police reports.

The ability to process and integrate large volumes of data in real time also facilitates rapid response to ongoing events and supports high-throughput reporting demands typical in modern policing environments. This real-time implementation is achieved through the novel use of advanced media processing tools and data standardization techniques, which together enable seamless conversion, aggregation, and formatting of diverse data streams as they are received. As a result, the system provides a concrete and tangible improvement to the technological infrastructure underlying law enforcement record-keeping and reporting, with direct benefits for operational efficiency, legal compliance, and public safety.

### VI. Interpretation

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A method for automated generation of police reports, comprising:
retrieving an event dataset associated with a target law enforcement event, the event dataset comprising textual event data and media event data, wherein,
the event dataset is retrieved from a distributed network system comprising a plurality of law enforcement databases;
processing the media event data to generate corresponding media-based textual data;
generating a textual event dataset comprising (i) the textual event data, and (ii) the media-based textual data;
processing the textual event dataset using a trained natural language model (NLM),
wherein the NLM is prompted to generate a police report according to a predefined set of rules; and
outputting the police report from the NLM.

2. The method of claim 1, wherein the police report includes a summary of details of the incident event, involved persons, description of located evidence and property, and actions taken by officers.

3. The method of claim 1, wherein the predefined rules comprise one or more of structural rules, naming rules, location rules, weather-related rules and unit conversion rules associated with standardized police officer reports, and
wherein the structural rules relate to a chronological organization of events in the textual data based on extracted time data.

4. The method of claim 1, wherein at least a portion of the media event data comprises recorded video data captured of the incident

5. The method of claim 1, wherein the plurality of databases comprise one or more of a dispatch system, a record management system (RMS) database, an officer notes database and document evidence management (DEM) database.

6. The method of claim 1, wherein the media event data comprises one or more of audio data and image data, relating to the target event, generated by one or more media devices.

7. The method of claim 6, further comprising initially operating the media devices to generate the media event data, and storing the media event data in one or more of the plurality of databases.

8. The method of claim 1, wherein processing the media event data to generate media-based textual data comprises one or more of processing:
the audio data to generate a textual transcription of the audio data; and
the image data to generate a textual transcription of the image data.

9. The method of claim 8, wherein prior to generating the textual event dataset, the method further comprises automatically generating a summary of the textual transcriptions of the image and audio data.

10. The method of claim 1, wherein the police report is output on a display interface of a user device, and the method further comprises receiving one or more edits to the police report.

11. A system for automated generation of police reports, comprising:
a distributed network system comprising a plurality of law enforcement databases; and
a non-transitory memory storing computer executable instructions, which when executed by at least one processor, cause the processor to execute a method comprising:
retrieving, from the distributed network system, an event dataset associated with a target law enforcement event, the event dataset comprising textual event data and media event data:
processing the media event data to generate corresponding media-based textual data;
generating a textual event dataset comprising (i) the textual event data, and (ii) the media-based textual data;
processing the textual event dataset using a trained natural language model (NLM),
wherein the NLM is prompted to generate a police report according to a predefined set of rules; and
outputting the police report from the NLM.

12. The system of claim 11, wherein the police report includes a summary of details of the incident event, involved persons, description of located evidence and property, and actions taken by officers.

13. The system of claim 11, wherein the predefined rules comprise one or more of structural rules, naming rules, location rules, weather-related rules and unit conversion rules associated with standardized police officer reports, and
wherein the structural rules relate to a chronological organization of events in the textual data based on extracted time data.

14. The system of claim 11, wherein at least a portion of the media event data comprises recorded video data captured of the incident.

15. The system of claim 14, wherein the plurality of databases comprise one or more of a dispatch system, a record management system (RMS) database, an officer notes database and document evidence management (DEM) database.

16. The system of claim 11, wherein the media event data comprises one or more of audio data and image data, relating to the target event, generated by one or more media devices.

17. The system of claim 16, further comprising initially operating the media devices to generate the media event data, and storing the media event data in one or more of the plurality of databases.

18. The system of claim 11, wherein processing the media event data to generate media-based textual data comprises one or more of processing:
the audio data to generate a textual transcription of the audio data; and
the image data to generate a textual transcription of the image data.

19. The system of claim 18, wherein prior to generating the textual event dataset, the method further comprises automatically generating a summary of the textual transcriptions of the image and audio data.

20. The system of claim 11, wherein the police report is output on a display interface of a user device, and the method further comprises receiving one or more edits to the police report.
